(19) United States
(12) Patent Application Publication
(10) Pub. No.: US 2006/0009173 A1
(43) Pub. Date: Jan. 12, 2006

(54) Step-up frequency converter

(76) Inventors: Hardial Singh Gill, Backnang (DE); Richard Krupa, Murrhardt (DE); Stefan Koch, Oppenweiler (DE)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/514,703

(22) PCT Filed: May 19, 2003
(86) PCT No.: PCT/IB03/02588

§ 371 Date: Jul. 18, 2005

(30) Foreign Application Priority Data
May 17, 2002 (DE) 102 22 622.9

(51) Int. Cl. H01Q 11/12; H04B 1/04

(52) U.S. Cl. 455/118

(57) ABSTRACT

A step-up frequency converter includes a first and a second input for two input signals that are to be mixed, the first input signal having a lower frequency than the second input signal, a first and a second control element each of which is provided with a control connection and two main connections, the flow of current between the main connections being controllable by means of a signal at the control connection, and an output for a mixed signal generated from the two input signals that are to be mixed. The control connections of the two control elements are connected to the second input signal in a counter-clocked mode while the first connections of the two control elements are connected to each other and to the output. A first symmetrizer connects the input for the first input signal to the first main connections of the two control elements.

Up-Converter

The present invention concerns an up-converter. Such frequency converters are required in radio communications systems to shift an intelligence signal at an intermediate frequency to a transmission frequency prescribed for radio transmission. The wavelengths of the radio signals can lie in the millimeter range.

The increasing extent of integration in communication systems for these wavelengths is also leading to an increased demand for space-saving monolithically integratable frequency converters.

An up-converter according to the preamble of claim 1 is known from Nishikawa et al., “Broadband and Compact SiBJT Balanced Up-Converter MMIC using Si 3-D MMIC Technology”, IEEE MMT-S International Microwave Symposium 2001, Phoenix, Ariz., USA, pages 87-90. In this known frequency converter, the two signals being mixed, an intermediate frequency signal and a local oscillator signal, are each in push-pull on the basis of two bipolar transistors and modulate currents flowing through the bipolar transistors that are superimposed additively on the high frequency signal to be emitted. The local oscillator signals of opposite phase applied to the bipolar transistors are delivered by a balun integrated on the substrate, to whose input the local oscillator signal is fed in asymmetric form. The balun is constructed from a number of conductor track sections, each with a length of λ/4, and occupies more space on the substrate of the integrated circuit than all other circuit components together.

The intermediate frequency signal, also required in symmetric form, whose frequency is lower than the local oscillator signal, is supplied to the circuit from the outside via two separate connections. Differences in feed lines to these two connections, lying outside of the integrated circuit, especially different lengths and damping, can lead to different amplitudes of the intermediate frequency signals and deviations in their phase difference from the desired exact antiphase state, and therefore asymmetry in behavior of the two bipolar transistors. The quality of the mixing result therefore depends, among other things, on the wiring of the circuit; the manufacturing tolerance spread in wiring can therefore adversely affect the effectiveness of the frequency converter.

The task of the present invention is to devise an integratable up-converter with a good, reproducible conversion behavior, little dependent on manufacturing tolerance spread.

The task is solved by an up-converter with the features of claim 1. By integrating a balun for the lower input frequency on the substrate, the length and damping of the connection between the balun and the first main connections of the two control elements are exactly controllable and reproducible.

A third control element is preferably used as balun for the lower input frequency, whose control connection is connected to the first input signal, and each of its two main connections is connected to one of two power supply potentials of the up-converter and a connection of the first and second control element. Such a balun requires very little substrate surface in comparison with the balun of the type used in Nishikawa et al., whose space requirement is proportional to the wavelength of the signal being balanced, and it has large bandwidth.

The connections of the first and second control element, with which the main connections of the third control element are connected, are preferably their second main connections. This permits multiplicative modulation of the first input signal by the second one, and therefore high efficiency of the mixing process.

Transistors, especially HEMTs (high electron mobility transistors), are preferably used as control elements.

In order to achieve high mixing efficiency, the first and second control elements are preferably biased into the vicinity of their pinch-off region.

A balun is also expediently provided for the second, higher frequency input signal, which is connected on the output side to the control inputs to the first and second control elements.

The object of the invention is also a single sideband frequency converter that can be implemented from the up-converters just described by connecting the outputs of two such up-converters to the inputs of a Lange coupler, one input of which forms the output of the single sideband frequency converter.

The second balun of the up-converter of such a single sideband frequency converter is expediently merged with a power divider, in order to save substrate surface. The power divider divides the second input signal in equal parts to the two up-converters. Such a merged or combined balun is simple to implement and space-saving with a first conductor section in the center, connected to a signal input of the signal sideband frequency converter and a number of second conductor sections on both sides of the first conductor section, in which the control inputs of the first and second control elements of the first up-converter are connected to the second conductor sections on one side of the center conductor section, and the control inputs of the first and second control elements of the second up-converter are connected to the second conductor sections on the other side of the center conductor section.

These conductor sections can be simply implemented as microstrip conductors in a common plane.

The second balun preferably has three adjacent conductor sections on both sides of the center conductor section, a center one of each being unconnected.

Additional features and advantages of the invention are apparent from the following description of a practical example with reference to the accompanying figures. In the figures:

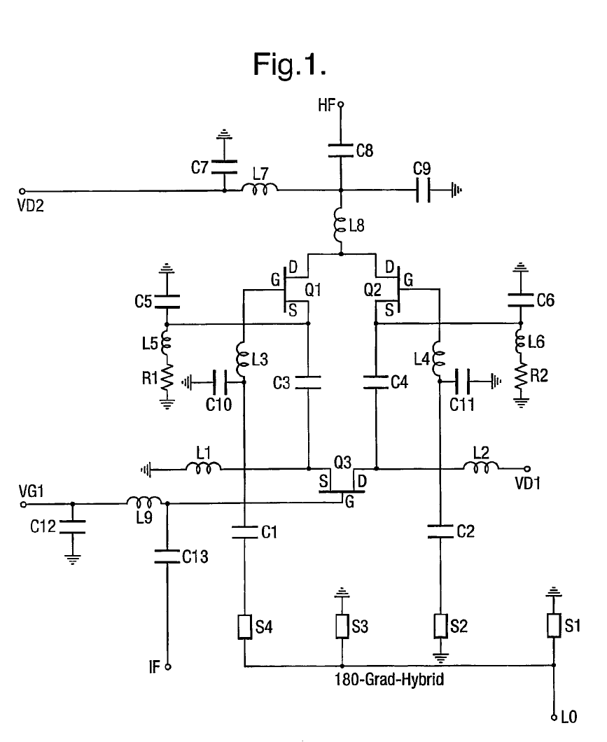

FIG. 1 shows a schematic circuit diagram of an up-converter according to the invention;

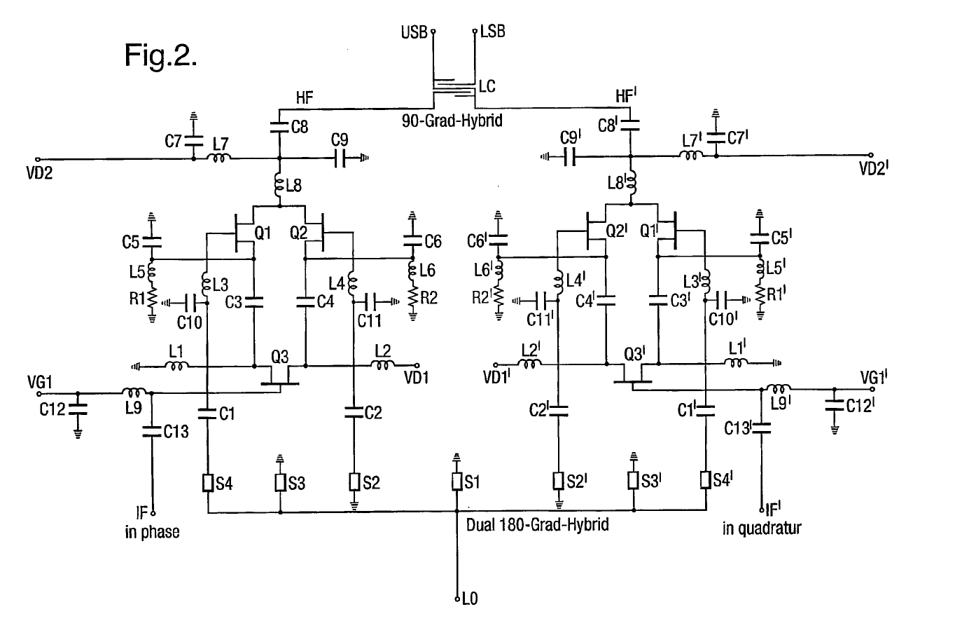

FIG. 2 shows a circuit diagram of a single sideband frequency converter;

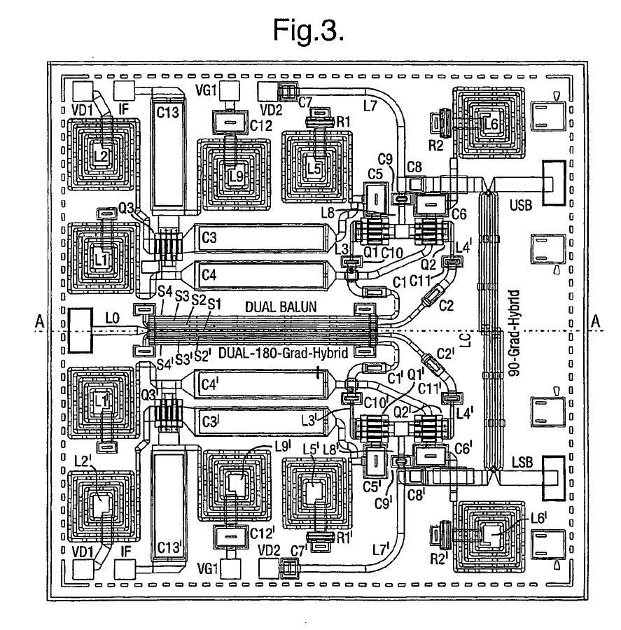

FIG. 3 shows a schematic depiction of a semiconductor substrate, on which a single sideband frequency converter from FIG. 2 is integrated.

FIG. 1 show a schematic diagram of an up-converter integrated on a substrate according to the present invention. This comprises, as control elements, two GaAs-HEMTs Q1 and Q2 in symmetric arrangement. The gates of the HEMTs Q1, Q2 are connected to a local oscillator signal LO via a 180° hybrid coupler, constructed from parallel strip conductors S1 to S4, and capacitors C1, C2 in push-pull. The drains of the HEMTs Q1, Q2 are connected to each other and via two inductances L8, L7 to an input connection for a power supply voltage VD2. The source of each HEMT Q1, Q2 is connected via a capacitor C3 or C4 to the source or drain of a third HEMT Q3 and via a capacitor C5 of C6 and via a series circuit to an inductance L5 or L6 and a resistor R1 or R2 to ground. A voltage drop produced by the source current of HEMT Q1 or Q2 on resistance R1, R2 closes automatic self-bias of the HEMT right below its pinch-off region.

The source and drain of HEMT Q3 are each connected via an inductance L1 or L2 to ground GND or a power supply potential VD1. A bias voltage VG1 is connected to the gate of HEMT Q3 via an inductance L9 and the intermediate frequency signal IF via a capacitor C13.

The voltage on the gate of HEMT Q3 therefore consists of a DC component contributed by VG1 and an AC component contributed by IF. The DC component is chosen, in such a way that the HEMT Q3 operates in the linear range; IF modulates the drain current of HEMT Q3 largely linearly. The potentials on the drain and source of HEMT Q3 therefore oscillate in antiphase to each other with a greater amplitude than that of the IF signal.

The HEMT Q3 therefore acts simultaneously as an amplifier and balun for the intermediate frequency signal IF. Generally, the same values of inductances L1, L2 are chosen in order to achieve equal amplitudes of the intermediate frequency signal at the source and drain of HEMT Q3.

The current flows through the two HEMTs Q1, Q2, at whose drain the power supply voltage VD2 lies via inductances L8, L7, consist mostly of a fraction with the frequency of the local oscillator LO, a fraction with the frequency of the intermediate signal IF and fractions in the sum and difference of the frequencies of local oscillator signal LO and intermediate frequency signal IF. Since the gates of HEMTs Q1, Q2 are connected in antiphase to the local oscillator LO, the fractions of these current flows are opposite and equal to the local oscillator frequency and cancel each other out. The intermediate frequency fractions are also opposite and equal and cancel each other out. The current flowing through inductance L3 and therefore the potential at the connection point between inductances L7, L8, obtains only spectral fractions with the sum or difference frequency. These fractions are coupled out via a capacitor C8 at the output HF and produce the output signal of the up-converter, a high frequency signal without carrier with two sidebands formed by the sum or difference frequency fraction.

FIG. 2 shows a single sideband converter, consisting of two step-up-converters of the type depicted in FIG. 1. The arrangement of the two step-up-converters is mirror-symmetric, their components have the same reference numbers in FIG. 2 as in FIG. 1, in which those of the second mixer in FIG. 2 are marked with an apostrophe ('). The intermediate frequency signal IF′ fed to the second mixer is phase shifted by 90° relative to the intermediate frequency signal IF. This means that, at the output HF′ of the second step-up mixer, one of the two sidebands is present in phase with the signal delivered by the first converter, but the other sideband is present in antuphase. The output signals of the two step-up-converters are superimposed in a Lange coupler LC, one of whose two outputs then delivers the upper sideband (USB), and the other the lower sideband (LSB).

FIG. 3 schematically depicts the arrangement of the different components of the single sideband mixer from FIG. 2 on a substrate. The two step-up mixers are arranged mirror-symmetrically on both sides of a center line A-A, shown with the dash-dot line. Along this center line A-A., a double balun extends, which includes seven parallel microstrip conductor sections S1, S2, S3, S4, S2′, S3′, S4′. A center section S1 is connected on one of its ends to a connection path for the local oscillator signal LO, the other end facing away from the LO connection path is placed at ground. From this center microstrip conductor SI, the following are arranged outward in series: a first microstrip conductor S2, S2′, which is connected on an end facing the local oscillator connection path LO to ground, and on an opposite end to HEMT Q2 or Q2′ via capacitor C2 or C2′, a second microstrip conductor S3, S3′, which is connected on its end facing the local oscillator connection path LO to the corresponding end of the microstrip conductor S1, and on its other end is placed at ground, like the microstrip conductor S1, as well as a third microstrip conductor S4, S4′, which is connected on its end facing the local oscillator path LO to S1, S3, S3′ and on its opposite end is connected to the HEMT Q1 or Q1′ via capacitor C1 or C1′.

The double balun therefore functions simultaneously as a power divider, which supplies the local oscillator signal LO with the same power to the two up-converters on both sides of center line A-A.

1-15. (canceled)

16. An up-converter, comprising:
a) a substrate;
b) a first and a second input for first and second input signals to be mixed, the first input signal having a lower frequency than that of the second input signal;
c) a first and a second control element each with a control connection, and two main connections having a current flow between the main connections controllable by a signal on the respective control connection;
d) an output for a mixed signal generated from the first and second input signals being mixed;
e) the control connections of the first and second control elements being connected in push-pull to the second input signal;
f) the first main connections of the first and second control elements being connected to each other and to the output; and
g) a first balun integrated on the substrate, and connecting the input for the first input signal to the first main connections of the first and second control elements.

17. The up-converter according to claim 16, in that the first balun is a third control element whose control connection is connected to the first input signal, and each of whose two main connections is connected to one of two power supply potentials and to a connection of one of the first and second control elements.

18. The up-converter according to claim 17, in that each main connection of the third control element is connected to a second main connection of one of the first and second control elements.

19. The up-converter according to claim 17, in that the control elements are transistors.

20. The up-converter according to claim 19, in that the transistors are HEMTs.

21. The up-converter according to claim 19, in that the third control element operates in its linear range.

22. The up-converter according to claim 19, in that the first and the second control elements are operated in the vicinity of their pinch-off region with bias.

23. The up-converter according to claim 22, in that the first and the second control elements are biased by automatic self-bias.

24. The up-converter according to claim 16, and a second balun connected, on an input side, to the second input for the second input signal and, on an output side, to the control connections of the first and second control elements.

25. A single sideband frequency converter, comprising:
A) two up-converters each including:
a) a substrate;
b) a first and a second input for first and second input signals to be mixed, the first input signal having a lower frequency than that of the second input signal;
c) a first and a second control element each with a control connection, and two main connections having a current flow between the main connections controllable by a signal on the respective control connection;
d) an output for a mixed signal generated from the first and second input signals being mixed;
e) the control connections of the first and second control elements being connected in push-pull to the second input signal;
f) the first main connections of the first and second control elements being connected to each other and to the output; and
g) a first balun integrated on the substrate, and connecting the input for the first input signal to the first main connections of the first and second control elements; and
B) the up-converters having outputs connected at inputs of a Lange coupler, one output of which forms an output of the single sideband frequency converter.

26. The single sideband frequency converter according to claim 25, in that a second balun is simultaneously designed as a power divider.

27. The single sideband frequency converter according to claim 26, in that the second balun has a center first conductor section connected to a signal input of the single sideband frequency converter, and on both sides of the first conductor section, a number of second conductor sections in which the control inputs of the first and second control elements of the first up-converter are connected to the second conductor sections on one side of the center conductor section, and the control inputs of the first and second control elements of the second up-converter are connected to the second conductor sections on the other side of the center conductor section.

28. The single sideband frequency converter according to claim 27, in that the conductor sections are microstrip conductor sections arranged in a common plane.

29. The single sideband frequency converter according to claim 27, in that the conductor sections are parallel and equidistant.

30. The single sideband frequency converter according to claim 27, in that the second balun has three adjacent conductor sections on both sides of the center conductor section, and in that a center one of the three adjacent conductor sections is connected on both ends to the center conductor section.
